(19) United States
(12) Patent Application Publication
(10) Pub. No.: US 2019/0240932 A1
(43) Pub. Date: Aug. 8, 2019

(54) TAPE-LAYING DEVICE AND TAPE-LAYING METHOD USING A PIVOTAL CUTTING DEVICE

(71) Applicant: DIEFFENBACHER GMBH MASCHINEN-UNDANLAGENBAU, Eppingen (DE)

(72) Inventor: Matthias GRAF, Eppingen (DE)

(73) Assignee: DIEFFENBACHER GMBH MASCHINEN-UND ANLAGENBAU, Eppingen (DE)

(21) Appl. No.: 16/328,604

(22) PCT Filed: Sep. 6, 2017
(86) PCT No.: PCT/EP2017/072385

§ 371 Date: Feb. 26, 2019

(30) Foreign Application Priority Data
Sep. 8, 2016 (EP) 10 2016 116 798.3

(51) Int. Cl. B29C 70/54; B29C 70/38

(52) U.S. Cl. CPC B29C 70/545; B29C 70/386

(57) ABSTRACT

A tape-laying device includes a material feed unit configured to feed a taps strip material; a cutting device having a cutter adjustable in angle about an axis of rotation (Z) for detaching a tape from the tape strip material; a support table; and a laying device configured to receive and place the detached tape on the support table. The cutting device has a flat transport element, The tape strip material is configured to be fed between the cutter and the flat transport element. The tape strip material is configured to be cut on or over the flat transport element in order to detach the tape from the tape strip material.

The present invention relates to a tape-laying device according to the preamble of claim 1, as well as to a tape-laying method according to the preamble of claim 13.

The applications for fiber composites have continued to increase over the past decades, especially when they could be regarded as an inexpensive alternative to metallic materials, with the advantages of freedom of design and application-specific formulation options. The material CFRP (carbon fiber reinforced plastic) in particular has an extremely high lightweight construction potential, wherein it is also characterized by its high strength and very high structural rigidity. The latter is an important criterion in automotive engineering, for example.

Current development activities for production systems for processing fiber composites, therefore, range from pure machine development to turnkey production systems. The former usually comprise preform manufacturing units, press units and optionally injection units, as well as post-processing units—the latter being the corresponding automation for preform handling, possible tool cleaning, component removal and the like.

The automated production of the preform is a key technology in the manufacturing process of endless fiber-reinforced fiber composite components for the realization of efficient mass production with reproducible stable component quality. But also in the case of so-called hybrid components, i.e. compression-molded sheets that are primarily pressed with carbon fiber semi-finished products in order to additionally strengthen critical load zones, it must be possible to integrate all production units in terms of plant and control technology if sufficient productivity is to be achieved.

Today, predominantly textile semi-finished products are used for the production of continuous fiber-reinforced components, in particular semi-finished fiber products such as those wetted with a binder (hot-melt adhesive) and/or fiber yarns partially or completely impregnated with a matrix and/or fabrics (so-called prepregs) such as fiber fabric, knitted fiber fabrics, fiber scrims or fiber mats. The matrix of fiber-reinforced plastics has the task of embedding the heavy-duty fibers (supporting function) and completely filling in the space between them (blocking function).

Materials from the groups of thermoplastics or thermosets and, optionally, of additional elastifying components such as elastomers, which differ in strength, maximum elongation, application temperature, processing speed, and chemical resistance, can be used in principle on binder and/or matrix materials. Duroplastic molding compounds can be plasticized by the action of temperature, are moldable at this moment and then harden irreversibly under pressure and temperature. In contrast to thermoplastics, elastomers and thermosets (also called duromers) consist of more or less strongly crosslinked macromolecules after processing, i.e. in the ready-to-use state, which are usually neither fusible nor soluble.

From these semi-finished products, which are available as rolls or sheet merchandise in standard formats, blanks are produced in a cutting process, which usually line the entire surface of the formed component. When cutting the blanks, a significant amount of cutting waste is produced, depending on the component geometry, which cannot be processed and considerably reduces the efficiency of this process.

In order to improve resource efficiency, endless fiber-reinforced components can be manufactured using fiber or tape-laying methods, which have become known, with considerably less waste or without waste. Especially the use of tapes made of thermoplastic continuous fibers proves to be a very attractive process variant. The laying of the fiber composite material, usually available as tape, for the construction of a laminate, poses a particular challenge.

In the context of this invention, a tape is preferably any type of web material, in particular a prepreg material having a width, for example, between 30 and 200 mm, which is suitable for placement by means of a tape-laying device. “Prepreg material” in the present case means in particular fiber yarns (rovings), fiber scrims and/or fiber fabrics, which are wetted with a binder and/or partially or completely impregnated, in particular pre-impregnated, with a matrix, for example, a thermoset matrix or thermoplastic matrix.

The fibers are in particular carbon fibers, but can also be used for glass fibers or other fibers, in particular artificially produced fibers.

The tape may be arranged on a carrier material, in particular a carrier foil or a carrier paper, which is detached from the carrier material during the laying of the tape for the construction of the laminate, wherein the carrier material is removed, for example wound up, by means of a suitable device of the tape-laying device. However, tapes that no longer require carrier materials can also preferably be used.

For the processing of tapes, it is known to pull them off a spool or roll, cut them to length and place them on a support table or on a tape structure already placed on the support table. When a tape strip or a tape is laid down, it is connected to the underlying tape layer spot by spot using a number of ultrasonic welding heads.

For the processing of tapes and for carrying out a tape-laying method, automatic devices are often used, which are able to place a tape in a structured way. Especially well-known are so-called tape-laying devices, which in this case also include a so-called fiber placement device.

An exemplary tape-laying device is known from document WO 2014/083196 A1, which describes a tape-laying device having several material feeding units for feeding tape strip material. With the respective gripping mechanisms, strips are pulled out of the material feeding units and cut to length with cutting devices, so that the respective tape strips or tapes are detached from the tape strip material. The tapes are then positioned in guide tracks and the respective tape stitching units are used to place the tapes on the processing surface of a support table. The support table can move as required so that the strips can be placed in the desired positions and orientations. The tapes are detached in one direction transverse to the longitudinal direction of the tape strip material, so that rectangular strips are detached in each case.

Such tape-laying devices are mostly used to cover component-specific surfaces with various component contours. With curved contour sections, this requires that the contour can only be approximated in a zigzag approximation using the rectangularly cut tapes. Depending on the course of the contour and the tape width, an undesirable material waste occurs. The material waste could be reduced by reducing the tape width, i.e. by laying narrower to very narrow tapes next to each other, which in turn has the disadvantage that the laying rate is reduced and the total time required to lay the desired component is increased accordingly.

U.S. Pat. No. 8,048,253 B2 also describes a tape-laying device in which a tape strip material is fed to respective cutting devices, which cut off respective tapes, which are then placed on the working surface of a support table. The tape strip material and the detached tapes are each guided in guide rails arranged on either side of the tape or strips, wherein the edges of the tape or strips are held in grooves provided in the guide rails. The transport of the tape or tape strip material is carried out by means of driven rollers. The document also suggests that the cutting devices should each have a cutting blade unit that can be pivoted about a vertical center axis. In this way, it is possible to cut the tape strip material at a correspondingly adjustable angle. In order to avoid sagging of the tape strip material or cut-off tape strips in front of or behind the cutting blade unit, it is proposed that the lateral guide rails holding the tape strip material or cut-off tape are adjustable in the longitudinal direction of the tape and are adjusted according to the pivoting of the cutting blade unit.

By adjusting the cutting blade unit accordingly, it is possible to cut the respective tapes approximately to the desired component contour to be laid, so that unwanted material waste can be reduced. However, the disadvantage here is that the roller drive, which is required for transporting the detached tapes and is arranged downstream of the cutting blade unit, is arranged at a sufficient distance from the pivot axis of the cutting blade unit to enable the cutting blade unit to pivot in a sufficiently large angular range. Especially in tape-laying devices where wider tapes are also to be processed, e.g. tapes 150 mm wide, 200 mm wide or more, and with large pivot angles of 45°, 60° or more, this may result in the roller drive having to be positioned at a distance of 100 mm, 150 mm or more behind the cutting blade unit. Accordingly, it is no longer possible in this way to cut and lay shorter tapes, which are shorter in length, as in this case it would no longer be possible to feed and transport the tapes through the roller drive. This also has a corresponding effect on material waste, since each tape waste must have a minimum length in order to be safely discharged from the system.

In addition, both of these well-known tape-laying devices have the disadvantage that because the tape strips or tapes are only guided and held laterally by the guide rails, the tape material to be processed must have a sufficiently high internal stiffness so that the tape material does not sag and fall out of the guide rails. This can represent an undesirable restriction with regard to the materials, thicknesses and/or widths that can be processed.

It is, therefore, an object of the invention to indicate an improved tape-laying device and an improved tape-laying method, which overcomes the foregoing disadvantages.

It is a further object of the invention to indicate an improved tape-laying device and an improved tape-laying method, which make it possible to lay a tape by means of short and ultra-short tapes with as little material waste as possible.

It is yet a further object of the invention to indicate an improved tape-laying device and an improved tape-laying method, which can be used flexibly and quickly for the efficient laying of tape material of different widths.

These and other objects of the present invention are solved with a tape-laying device and a tape-laying method. Further preferred embodiments are set out in the dependent claims.

A tape-laying device is provided as a solution, comprising a material feed unit for feeding a tape material, a cutting device having a cutting means angularly adjustable about an axis of rotation for detaching a tape from the tape material, and a laying device for receiving and placing the detached tape on a support table. The cutting device has a flat transport element, wherein the tape strip material can be fed between the cutting means and the flat transport element and the tape strip material can be cut on or above the flat transport element in order to separate the tape from the tape strip material.

The axis of rotation is preferably arranged substantially perpendicular to the plane of the support surface of the flat transport element and is thus substantially perpendicular to the plane in which the tape material is fed.

The flat transport element is preferably designed as an endless conveyor belt rotating around deflection rollers. Alternatively, it may be provided that the flat transport element is designed as a plate-shaped support surface, such as a metal plate, a plastic plate, a metal plate coated or covered with a plastic material and so on, wherein the plate-shaped support surface is movable in and against the transport direction of the tape strip material.

By providing a flat transport element, which, in the case of the flat transport element being designed as an endlessly circulating conveyor belt, moves continuously in the transport direction of the tape strip material underneath the cutting means, or which, in the case of the flat transport element being designed as a plate-shaped support surface, moves underneath the cutting means in the transport direction of the tape strip material in order to receive the tape strip material, move it underneath the cutting means and/or, after the tape has been cut off, move it further in the direction towards the laying device or moves a feeding device optionally arranged between the laying device and the cutting device counter to the transport direction of the tape strip material in order to be brought into an initial position so as to subsequently enable a further separation of a further tape by renewed movement in the transport direction of the tape strip material, and in that the separation and severing of individual tapes from the tape strip tape material is carried out on or above the flat transport element, it is achieved that a respectively detached tape falls onto or rests on the flat transport element immediately behind the cutting means and can be safely transported further by the flat transport element. In this way, it is possible to use the tape-laying device to lay short and ultra-short tapes, especially short and ultra-short tapes cut at an angle.

Preferably, a vacuum device can be further provided in or connected to the cutting device, which is connected to the flat transport element in such a way as to hold the tape strip material and/or the detached tapes on the flat transport element by means of a vacuum generated by the vacuum device. In this way, the tape strip material and/or a detached tape can be securely held on the flat transport element without leading to undesirable changes in position during the severing and/or transport of the tape strip material and/or the detached tape, which could lead to inaccurate placement of the tape.

It may be provided that in the cutting device the tape strip material is fed to the flat transport element, in particular to the flat transport element designed as a conveyor belt, resting between the cutting means and the flat transport element, and the tape strip material is cut resting on the flat transport element. In an advantageous further development, it can be provided that the cutting means cuts in a range from 0 to 3 mm, preferably in a range from 0.3 mm to 2 mm, especially preferably in a range from 0.5 mm to 1.5 mm into the flat transport element.

Alternatively, it can be provided that the cutting device further comprises a cutting plate which is arranged above the flat transport element, in particular the flat transport element designed as a conveyor belt, and in front of the cutting means in the transport direction of the tape strip material, wherein the tape strip material is guided resting on the cutting plate, wherein the cutting plate is pivotal together with the cutting means, and wherein the cutting plate defines a cutting edge along which the cutting means cuts the tape strip material for detaching the tape. In particular, the cutting plate may be semi-circular and/or have a thickness in the range 1 to 5 mm, preferably in the range 2 to 4 mm, and in particular a thickness of 3 mm.

The use of a cutting plate in the cutting device offers several advantages: On the one hand, the cutting plate forms a cutting edge and thus serves as a counter blade for the cutting means. On the other hand, the cutting plate shields the tape strip material from the flat transport element, which can run underneath the cutting plate. In particular, when the flat transport element is connected to a vacuum device, the cutting plate serves to shield the tape strip material from the flat transport element and only the cut tapes are held on the flat transport element by means of the generated vacuum.

In an advantageous embodiment, the cutting means has a guide edge, which extends over the cutting plate, so that a cut is always made along the cutting edge of the cutting plate.

As an alternative or in combination to the aforementioned embodiments, the cutting edge of the cutting plate and the cutting edge of the cutting means are not aligned parallel, but form an opening angle, so that a lifting movement of the cutting means cuts off a tape from the tape material, similar to a scissor cut.

Preferably, the cutting means is designed as a cutting blade. In particular, the cutting blade is preferably mounted in the area of one end on a pivot joint so that it can pivot about a horizontal axis and is guided in the area of the other end in a slotted guide.

It may also be provided that the cutting means is subjected to ultrasonic sound by means of an ultrasonic device in order to support the cutting of the tape strip material into tapes.

The laying device preferably has a flat transport element, for example an endless conveyor belt rotating around deflection rollers, and a vacuum device connected to the flat transport element, wherein the individual tapes can be picked up on an underside of the laying device and can be held on the flat transport element by means of the vacuum generated by the vacuum device. Alternatively and/or in addition, it may be provided that at least one feeding device is arranged between the cutting device and the laying device, which feeding device has a flat transport element, for example an endless conveyor belt rotating around deflection rollers, and is arranged in such a way as to receive detached tapes in the cutting device and feed them to the laying device, wherein the individual tapes are transported lying on the flat transport element.

As flat transport elements, conveyor belts, which are guided endlessly at deflection rollers, or transport elements with a plate-shaped support surface, for example transport trays, which are movable in and against the transport direction, can be considered in the laying device and/or feeding device.

By transporting and laying tapes by means of flat transport elements such as conveyor belts, it is possible to use tape strip material of different widths and to quickly change between different widths without having to reconfigure the tape-laying device. In particular, it is not necessary to reconfigure guide rails for the tapes and adjust them to a new width, as is known in the prior art. At the same time, the transport and storage of tapes by means of flat transport elements, such as conveyor belts or transport plates, also makes it possible to lay tapes with a large width and low internal stiffness, since there is no danger of the tapes falling out of the guide rails provided for this purpose.

Alternatively or in combination, the cutting device can also be designed as a feeding device. The tape strip material can thus be cut into a tape by the cutting blade in the cutting device and the conveyor belt of the cutting device can then feed this tape to the laying device.

As a further solution, a tape-laying method is indicated, comprising: feeding a tape strip material by means of a material feed unit; detaching a tape from the tape strip material by means of a cutting device, wherein the cutting device comprises an angle-adjustable cutting means, and receiving and placing the detached tape on a support table by means of a laying device, wherein the cutting device comprises a flat transport element, and wherein the tape strip material is fed between the cutting means and the flat transport element and the tape strip material is placed on the support table by means of a laying device, and wherein the tape strip material is fed between the cutting means and the flat transport element and the tape strip material is cut on or above the flat transport element in order to separate the tape from the tape strip material.

The flat transport element is preferably designed as an endless conveyor belt rotating around deflection rollers. Alternatively, the flat transport element has a plate-shaped support surface that can be moved in and against the transport direction of the tape strip material.

It is also preferably provided that the tape strip material and/or the detached tape is held on the flat transport element by means of a vacuum generated by a vacuum device.

In a preferred further development of the method, it can be provided that in the cutting device the tape strip material is fed lying on the flat transport element between the cutting means and the flat transport element and the tape material is cut lying on the flat transport element.

Alternatively, it may be provided that the cutting device further comprises a cutting plate which is arranged above the flat transport element and in the transport direction of the tape strip material in front of the cutting means, wherein the tape strip material is guided lying on the cutting plate, wherein the cutting plate is pivoted together with the cutting means, and wherein the cutting plate defines a cutting edge along which the cutting means cuts the tape strip material for detaching tapes.

It may also preferably be provided that the laying device has a flat transport element, preferably an endless conveyor belt rotating around deflection rollers, and a vacuum device connected to the flat transport element, wherein the individual tapes are received on an underside of the laying device and are held on the flat transport element by means of the vacuum generated by the vacuum device, and/or that at least one feeding device is arranged between the cutting device and the laying device, which feeding device has a flat transport element, preferably an endless conveyor belt rotating around deflection rollers, wherein tapes detached off in the cutting device are received by the feeding device, transported resting on the flat transport element and fed to the laying device.

It may also preferably be provided that a side edge of the tape strip material or the tape serves as a guide edge, which remains unchanged in position, so that a change in the width of the tape strip material affects only the opposite side, wherein the guide edge preferably coincides with a side edge of the flat transport element of the cutting device and/or with a side edge of the flat transport element, the feeding device and/or the laying device, in particular with a side edge of the conveyor belt of the aforementioned devices.

The tape-laying method can preferably be carried out with a tape-laying device as specified above.

The invention will be described below by means of exemplary embodiments, with reference to the drawings:

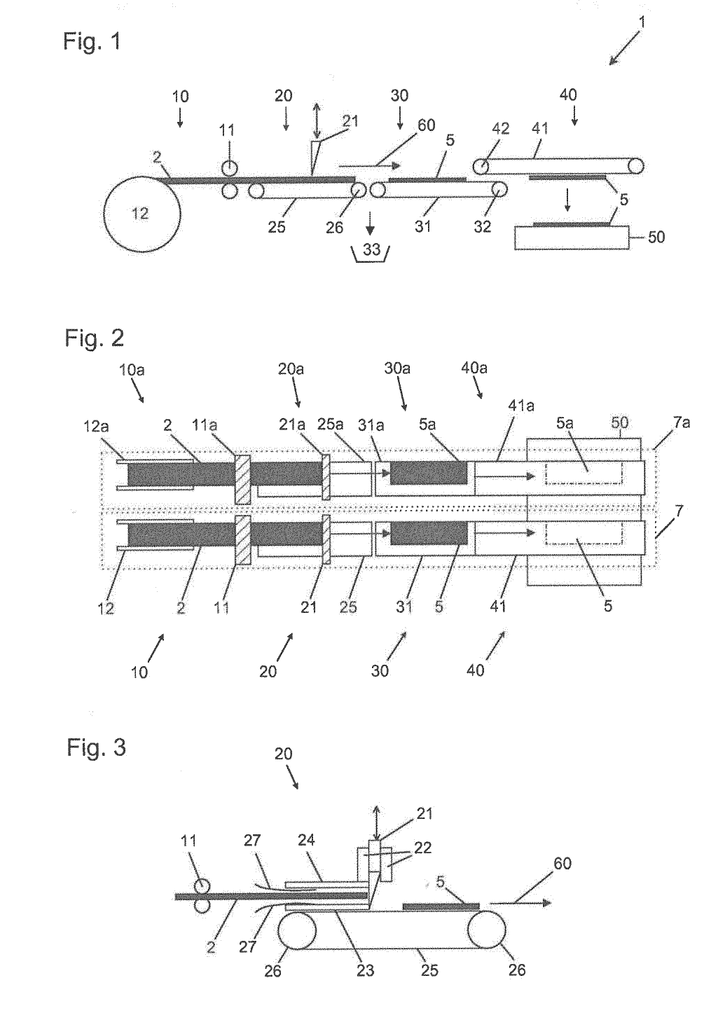

FIG. 1 shows a tape-laying device according to a preferred embodiment in a schematic cross-sectional view from the side;

FIG. 2 shows the tape-laying device of FIG. 1 in a schematic plan view;

FIG. 3 schematically shows a cutting device according to one embodiment in a side view;

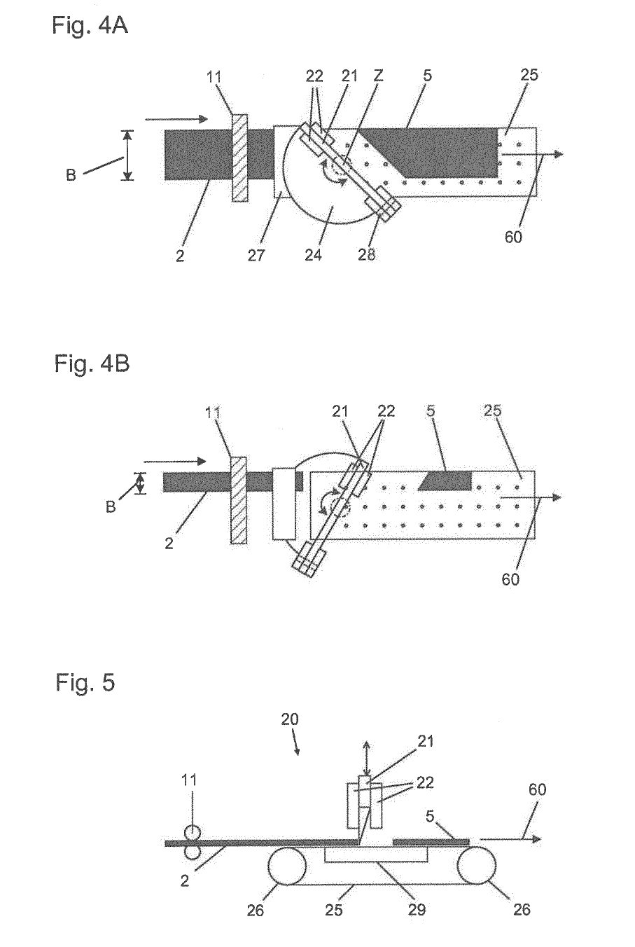

FIGS. 4A, 4B represent in a schematic plan view the cutting device of FIG. 3 in different angular positions; and

FIG. 5 represents schematically a cutting device according to another embodiment.

FIG. 1 shows a tape-laying device 1 in a schematic cross-sectional view in accordance with an embodiment. As shown in FIG. 1, in the tape-laying device 1, a tape strip material 2, which, for example, is provided wound on a reel 12, is unwound from the reel 12 by means of a material feed unit 10 and fed to a cutting device 20 downstream of the material feed unit 10. For this purpose, the material feed unit 10 can have a pair of drive rollers 11, which form a roller drive, also known as a mangle drive, which provides for the transport of the tape strip material 2. The drive rollers 11 are driven by one or more motors (not shown) under control of a control device (not shown) so that the tape strip material 2 is “pushed” into the cutting device 20 at a desired speed and/or a desired length and fed in such a way.

In the cutting device 20, the tape strip material 2 is cut by means of a cutting means, which, for example, is designed as a cutting blade 21, in order to separate individual tapes 5 of a desired length from the tape strip material 2. The cutting blade 21 is angularly adjustable, so that not only can cuts be made transversely to the direction of the tape or to the transport direction 60 of the tape material strip 2, but by means of a corresponding adjustment of the cutting blade 21 by an angle of for example ±45° relative to the transverse direction of the tape strip material 2, which extends along its width, tapes 5 can also be cut, which are cut at a corresponding desired angle.

After the tapes 5 have thus been detached and singularized from the tape strip material 2 in the cutting device 20, the tapes 5 are transferred to a feeding device 30, which feeds the tapes 5 to a laying device 40 and transfers them to this device.

Such tapes 5, which are not usable for further productions, as well as waste material for e.g. correction cuts, can be ejected from the tape-laying device 1 between the cutting device 20 and the feeding device 30 and can be supplied, for example, to a discharge container 33.

The laying device 40 is arranged above a support table 50 and can be moved vertically relative to the support table 50 so that the laying device 40 can place and deposit a single tape 5 on the support table 50. For example, a linear guide (not shown) may be provided by means of which the laying device 40 can be lowered vertically onto the support table 50 in order to place the tapes 5 on a working surface of the support table 50, or on a tape structure already previously formed on the working surface of the support table 50, and, if necessary, be pressed on briefly and lightly. After the tape 5 has been laid down, the laying device 40 is lifted again to pick up a next tape 5. It should be noted that, for the purposes of this document, both the placement and laying of a tape 5 on the work surface of the support table 50 and the laying of a tape 5 on tape 5 previously placed on the support table 50, in particular on a previously formed tape layer, are to be understood as the placement and laying of tape 5 on the support table 50.

In order to enable the lowering of the laying device 40, the embodiment of FIG. 1 may provide that the feeding device 30 is also vertically lowered and raised together and jointly with the laying device 40. This can be done, in particular, by combining the feeding means 30 and the laying means 40 into a unit called the laying head 7, as further explained in closer detail below with reference to FIG. 2, and the laying head 7 is moved as a whole vertically to lay a tape 5. Alternatively, it is also conceivable to design the laying head 7 or the laying device 40 in a fixed manner and to design the support table 50 in a liftable manner so that the support table 50 is lifted for laying the tape 5. Furthermore, it is preferred that the support table 50 can be rotated around a vertical rotation axis Z under control of the control device (not shown) and/or can be moved in horizontal direction in the x- and/or y-direction in order to enable a desired relative positioning of the tape 5 relative to the support table 50.

In order to increase the laying rate, it is intended in particular that several tapes 5 are handled simultaneously, i.e. in particular at the same time and in a multi-track manner, wherein such parallelization advantageously multiplies the number of tapes 5 laid per sequence accordingly. Accordingly, the tape-laying device 1 of this embodiment, as shown in the plan view in FIG. 2, preferably provides for the corresponding units to be provided in a correspondingly multiple design. Thus, as shown in FIG. 2, two reels 12, 12a can be provided in each case, from which by means of two material feed units 10, 10a with a total of two pairs of drive rollers 11, 11a two strands of a tape strip material 2 are drawn off and fed to two respective cutting devices 20, 20a, where by means of two cutting blades 21, 21a two respective tapes 5, 5a are cut off and by means of two feeding devices 30, 30a are fed to two laying devices 40, 40a. By means of the two laying devices 40, 40a two tapes 5, 5a can be placed and laid simultaneously on the support table 50.

As indicated in FIG. 2, the material feed unit 10a, the cutting device 20a, the feeding device 30a, and the laying device 40a or the material feed unit 10, the cutting device 20, the feeding device 30 and the laying device 40 can each be combined in each case in a laying head 7 or 7a. However, this is not restrictive and it is also possible that a laying head 7, 7a comprises only the laying device 40, 40a or, in addition to the laying device 40, 40a, also the feeding device 30, 30a and, where appropriate, the cutting device 20, 20a.

As in the case of the tape-laying devices 1 known in the prior art, the laying heads 7a, 7b or the units contained therein are so arranged that in one working cycle two or more tapes 5, 5a which are to be deposited simultaneously and each have a width B are laid at a distance from one another around this width B or around a multiple of this width B, wherein the remaining gaps between tapes 5, 5a which have already been laid are filled by laying further tapes 5, 5a in one or, if appropriate, several subsequent working cycles in order to form a closed tape layer. It may also be provided that, as is known, during the laying of tapes 5, 5a, previously laid tapes 5, 5a are attached to the previously laid tape layers, for example by means of ultrasonic devices provided for this purpose, for example by plasticizing, or are at least partially consolidated with the underlying tape layers to form a laminate. This procedure can be repeated for each additional tape layer.

As shown in FIGS. 1 and 2, the laying device 40, 40a, the feeding device 30, 30a and the cutting device 20, 20a are preferably designed with conveyor belts 25, 25a, 31, 31a, 41, 41a as flat transport elements, which rotate endlessly around respective deflection rollers 26, 32, 42. In the feeding device 30, 30a, the tapes 5, 5a are transported lying on top, i.e. lying on an upper side of the feeding device 30, 30a on the conveyor belt 31, 31a. On the other hand, the individual tapes 5, 5a are each transported in the laying device 40, 40a in a “suspended” manner. For this purpose, the laying device 40, 40a is preferably provided with a vacuum device (not shown) which is connected to the conveyor belt 41, 41a of the laying device 40, 40a in such a way that air can be sucked in through the conveyor belt 41, 41a and a vacuum can be built up in such a way, for example, by providing a plurality of openings in the conveyor belt 41, 41a through which the air can be sucked in. As a result of the vacuum thus produced, a tape 5, 5a lying on the conveyor belt 31, 31a of the feeding means 30, 30a and supplied to the laying device 40, 40a can be sucked in so that it is held on the underside of the laying device 40, 40a adjacent to the conveyor belt 41, 41a.

The vacuum device can be switched off after the tape 5, 5a has been placed on the support table 50.

With reference to FIGS. 3, 4A and 4B, a possible embodiment of the cutting device 20 of FIGS. 1 and 2 is now described in greater detail, wherein FIG. 3 shows a position of the cutting blade 21 for a cut transverse to the strip direction, while FIGS. 4A and 4B each show different positions of the cutting blade 21 that are pivoted thereto for an “oblique” or angular cut of tape 5.

As shown in FIGS. 3, 4A and 4B, the cutting device 20 has a cutting blade 21 as cutting means, which is arranged above the conveyor belt 25. The cutting blade 21 is pivotably mounted at one end with a pivot joint 28 and mounted at its other end in a slotted guide 22 so that the cutting blade 21 can perform a cutting movement by raising and lowering the slotted end by means of an actuating device (not shown). On the side of the cutting blade 21 facing the material feed unit 10, a cutting plate 23 is arranged above the conveyor belt 25. The cutting plate 23 is preferably designed as a thin metal sheet of between 1 and 4 mm thickness, preferably between 1.5 and 3 mm thickness and particularly preferably with a thickness of 2 mm, and can be arranged at a distance of less than 2 mm, preferably less than 1 mm, particularly preferably less than 0.5 mm from the conveyor belt 25.

The tape strip material 2 is now pushed or conveyed by the drive rollers 11, and optionally under guidance by an upper and a lower guide plate 27 and a cover plate 24, over the cutting plate 23 into the space between the cutting blade 21 and the conveyor belt 25. Since the tape strip material 2 is fed as an endless tape there, it is possible to slide it over the cutting plate 23 without any problems. Beyond the cutting blade 21, the tape band material 2 falls onto the conveyor belt 25 and, by corresponding control of the movement of the conveyor belt 25 around the deflection rollers 26 by means of the drive rollers 11, is further transported by a control device (not shown) until a desired length of the tape 5 to be cut off is reached. In this position, the conveyor belt 25 and the drive rollers 11 for cutting the tape 5 are stopped. Alternatively, the conveyor belt 25 can also stand still as long as the tape strip material 2 is conveyed with the drive rollers 11 and can slide over the conveyor belt 25.

As can be seen in FIGS. 3, 4A and 4B, the cutting plate 23 has a straight edge, which serves as a counter blade along which the blade of the cutting blade 21 cuts in the manner of a scissor cut in order to cut the tape strip material 2 and separate the tape 5 from it. After the cut has been made, the end of the freshly cut tape 5 on the cutting blade side also falls onto the conveyor belt 25 and can be transported further by this in the direction of the laying device 40. Since the cut tape 5 thus always comes to rest on the conveyor belt 25, it can be safely and reliably transported away even in the case of short and ultra-short cutting lengths, for example, in the case of tapes 5, which only have a length of 10 mm, 5 mm or less.

Furthermore, the aforementioned configuration means that tape waste pieces, such as those produced by adjusting the cutting angle to the geometry of the tape structure to be laid, can be safely picked up by the conveyor belt 25 and ejected from the tape-laying device 1.

The reliable pick-up of tape strip 5 on the conveyor belt 25 can be further improved in a preferred configuration if the conveyor belt 25 is designed as a vacuum belt and the tape strip 5 can be adhered and fixed on the conveyor belt 25 during or after the cutting process as a result of a slight vacuum.

The cutting plate 23 is preferably mechanically connected to the slotted guide 22, in which the cutting blade 21 is guided, and the unit consisting of cutting plate 23, slotted guide 22, cutting blade 21 and pivot joint 28 is rotatably mounted about an axis of rotation Z, which is preferably arranged substantially perpendicular to the plane of the support surface of the conveyor belt 25 and thus substantially perpendicular to the plane, in which the tape strip material 2 is fed, and can be continuously adjusted in rotation angle by means of a rotary drive (not shown) under control of the control device (not shown), for example, in a range of ±50°, in order to set a desired cutting angle in which a tape 5 is to be cut. Irrespective of the cutting angle, the detached tape 5 always falls completely onto the conveyor belt 25.

As further shown in FIGS. 4A and 4B, with the cutting device 20 of this embodiment it is also possible to use tape strip materials 2 of different widths without having to reconfigure the cutting device 20. It is particularly advantageous in this case if one side edge of the tape strip material 2 serves as the guide edge, which, in particular, is aligned in a fleeting manner with the same side edge of the flat transport element, such as the conveyor belt 25. This can be supported, for example, by arranging a lateral guide plate (not shown) on this side edge of the conveyor belt 25, which serves as a stop and guide for the tape strip material 2 or for tapes 5 detached from it. In this way, it is possible to ensure that the position of this side edge of the tape strip material 2 or tape 5 relative to the conveyor belt 25 remains constant, unchanged in position and well defined. Accordingly, different widths of the tape strip material 2 or the tape 5 detached from it only affect the position of the opposite side edge, which position is defined starting from the leading edge and by the known width of the tape strip material 2 or the tape 5. In this way, it is possible to achieve a well-defined and exact positioning of the tape 5 on the conveyor belt 25, and consequently also in the feeding device 30 and the laying device 40, even when using tape strip materials 2 of different width, and thus ensure a high laying precision.

A further possible embodiment of the cutting device 20 is shown in FIG. 5, wherein in this embodiment the cut is made directly on the conveyor belt 25. Accordingly, only the cutting blade 21, the slotted guide 22 and the pivot joint 28 need to be provided in this embodiment, which, in turn, can be designed as a unit with an infinitely variable angle of rotation, mounted so as to rotate about an axis of rotation Z, as described above. The cutting blade 21 can advantageously cut slightly into the conveyor belt 25, for example in a range from 0 to 3 mm, preferably in a range from 0.3 mm to 2 mm, especially preferred in a range from 0.5 mm to 1.5 mm. The conveyor belt 25 thus serves as a cutting die. A support plate 29 is preferably provided in the region of the cutting blade 21 or in the region in which the cutting blade 21 can be pivoted, on which the conveyor belt 25 extends in contact, wherein the support plate 29 prevents the conveyor belt 25 from bending during cutting under the force of the cutting blade 21. It may also be preferable that, after cutting and detaching tape 5 from tape strip material 2, only the conveyor belt 25 is initially moved, while the drive rollers 11 remain stationary. Tape 5 can thus be moved away from the end of tape strip material 2 so that a distance is created to the next tape 5 to be cut.

The embodiment of FIG. 5 has the advantage over the embodiment of FIGS. 3 and 4A to 4B of a simpler, more compact and more cost-effective design, although it should be noted that the conveyor belt 25 can wear out in the course of time due to repeated cutting by the cutting blade 21 and must be replaced.

In addition, it may also be provided in the case of the cutting device 20 of this embodiment, as well as generally for the feeding device 30 and the laying device 40, that the side edge of the tape strip material 2 or of the tape 5 serves as a guide edge, which, in particular, is aligned in a fleeting manner with a same side edge of the flat transport elements such as, for example, the conveyor belts 25, 31 and/or 41.

While in the above description of the preferred embodiment a cutting device 20 is designed with an endless conveyor belt 25 rotating around deflection rollers 26, this is not restrictive, and the conveyor belt 25 can also be replaced by other types of flat transport elements. For example, it may be provided that the cutting device 20 has a flat, in particular plate-shaped, transport element with a plate-shaped support surface, which can be moved in and against the transport direction 60 of the tape strip material 2. For example, the flat transport element can be designed as a metal plate, a plastic plate, a metal plate or plastic plate coated or covered with a plastic or other material, which is stored and guided by means of a linear guide and which can be moved back and forth parallel to the transport direction 60 of the tape material by means of a traversing drive. The tape strip material 2 and/or the detached tapes 5 are deposited on the support surface formed by the surface of the plate-shaped transport element. The plate-shaped transport element can, in particular, also be integrated with a vacuum device to form a so-called “vacuum box”, wherein the vacuum device generates a vacuum with which the tape strip material 2 and/or detached tapes 5 are held on the support surface.

In addition, it is also conceivable to design the feeding device 30 and/or the laying device 40 in a corresponding manner with conveyor belts 31, 41 instead of the above described conveyor belts 31, 41, with flat transport elements too, such as in particular plate-shaped transport elements, which can also be moved back and forth in and against the transport direction 60 of the tapes 5.

### LIST OF REFERENCE NUMERALS P1525

| | |
|---|---|
| 1 | Tape-laying device |
| 2 | Tape strip material |
| 5 | Tape |
| 7, 7a | Laying head |
| 10, 10a | Material feed unit |
| 11, 11a | Drive rollers |
| 12 | Reel |
| 20.20a | Cutting device |
| 21, 21a | Cutting blades |
| 22 | Slotted guide |
| 23 | Cutting plate |
| 24 | Cover plate |
| 25, 25a | Conveyor belt |
| 26 | Deflection pulleys |
| 27 | Guide plate |
| 28 | Pivot joint |
| 29 | Support plate |
| 30, 30a | Feeding device |
| 31, 31a | Conveyor belt |
| 32 | Deflection pulleys |
| 33 | Discharge container |
| 40, 40a | Laying device |
| 41, 41a | Conveyor belt |
| 42 | Deflection pulleys |
| 50 | Support table |
| 60 | Transport direction |
| B | Width |
| Z | Axis of rotation |

1. A tape-laying device comprising:
a material feed unit configured to feed a tape strip material;
a cutting device having a cutter adjustable in angle about an axis of rotation (Z) for detaching a tape from the tape strip material;
a support table; and
a laying device configured to receive and place the detached tape on the support table,
wherein the cutting device has a flat transport element,
wherein the tape strip material is configured to be fed between the cutter and the flat transport element, and
wherein the tape strip material is configured to be cut on or over the flat transport element in order to detach the tape from the tape strip material.

2. The tape-laying device according to claim 1, wherein the flat transport element comprises
an endless conveyor belt configured to rotate around deflection rollers,
a plate-shaped support surface configured to move in a transport direction of the tape strip material and a direction opposite to the transport direction, or
a combination thereof.

3. The tape-laying device according to claim 1, wherein the cutting device further comprises a vacuum device connected to the flat transport element, the vacuum device being configured to hold the tape strip material, the detached tape, or a combination thereof on the flat transport element by a vacuum generated by the vacuum device.

4. The tape-laying device according to claim 1, wherein the tape strip material is configured to be fed in the cutting device lying on the flat transport element between the cutter and the flat transport element, and the tape strip material is configured to be cut resting on the flat transport element.

5. The tape-laying device according to claim 4, wherein the cutter is configured to cut into the flat transport element in a range from 0 to 3 mm.

6. The tape-laying device according to claim 1,
wherein the cutting device further comprises a cutting plate arranged above the flat transport element upstream of the cutting cutter with respect to a transport direction of the tape strip material,
wherein the tape strip material is configured to be guided resting on the cutting plate,
wherein the cutting plate is configured to pivot together with the cutter, and
wherein the cutting plate defines a cutting edge along which the cutter is configured to cut the tape strip material to detach the tape.

7. The tape-laying device according to claim 6, wherein the cutting plate is semicircular.

8. The tape-laying device according to claim 1, wherein the cutter comprises a cutting blade.

9. The tape-laying device according to claim 8, wherein the cutting blade is mounted in a region of one end of a pivot joint such that the cutting blade is pivotably mounted about a horizontal axis, and is guided in a region of an other end in a slotted guide.

10. The tape-laying device according to claim 1, further comprising a vacuum device,
wherein the laying device comprises a flat transport element including an endless conveyor belt configured to rotate around deflection rollers,
wherein the vacuum device is connected to the flat transport element, and
wherein individual detached tapes are configured to be received on an underside of the laying device and to be held on the flat transport element by a vacuum produced by the vacuum device.

11. The tape-laying device according to claim 1,
wherein at least one feeding device is arranged between the cutting device and the laying device, the at least one feeding device comprising a flat transport element including an endless conveyor belt configured to rotate around deflection rollers,
wherein the at least one feeding device is configured to receive detached tapes and feed the detached tapes to the laying device, and
wherein individual detached tapes are configured to be transported resting on the flat transport element.

12. A tape-laying method, comprising:
feeding a tape strip material via a material feed unit;
detaching a tape from the tape strip material via a cutting device having a cutter adjustable in angle about an axis of rotation (Z); and
receiving and laying the detached tape (5, 5a) on a support table via a laying device,
wherein the cutting device has a flat transport element, and
wherein the tape strip material is fed between the cutting device and the flat transport element, and the tape strip material is cut on or over the flat transport element in order to detach the tape from the tape strip material.

13. The tape-laying method according to claim 12, wherein the flat transport element comprises
an endless conveyor belt that rotates around deflection rollers,
a plate-shaped support surface that moves in a transport direction of the tape strip material and a direction opposite to the transport direction, or
a combination thereof.

14. The tape-laying method according to claim 12, wherein the cutting device further comprises a vacuum device connected to the flat transport element such that the tape strip material, the detached tape, or a combination thereof is held on the flat transport element by a vacuum generated by the vacuum device.

15. The tape-laying method according to claim 12, wherein the tape strip material is fed in the cutting device resting on the flat transport element between the cutter and the flat transport element, and the tape strip material is cut resting on the flat transport element.

16. The tape-laying method according to claim 12,
wherein the cutting device further comprises a cutting plate arranged above the flat transport element upstream of the cutter with respect to a transport direction of the tape strip material,
wherein the tape strip material is guided resting on the cutting plate,
wherein the cutting plate is pivoted together with the cutter, and
wherein the cutting plate defines a cutting edge along which the cutter cuts the tape strip material to detach the tape.

17. The tape-laying method according to claim 12, further comprising a vacuum device,
wherein the laying device comprises a flat transport element including an endless conveyor belt that rotates around deflection rollers,
wherein the vacuum device connected to the flat transport element,
wherein individual detached tapes are received on an underside of the laying device and are held on the flat transport element by a vacuum produced by the vacuum device,
wherein at least one feeding device is arranged between the cutting device and the laying device, the feeding device comprising a flat transport element including an endless conveyor belt that rotates around feeding deflection rollers,
wherein tapes detached in the cutting device are received by the feeding device, transported lying on the flat transport element of the feeding device, and fed to the laying device.

18. The tape-laying method according to claim 17,
wherein a side edge of the tape strip material or the detached tape serves as a guide edge that remains unchanged in its position, such that a change in a width of the tape strip material affects only an opposite side,
wherein the guide edge coincides with a side edge of the flat transport element of the cutting device, a side edge of the flat transport element of the feeding device, a side edge of the flat transport element of the laying device, or a combination thereof.

19. The tape-laying device according to claim 6, wherein the cutting plate has a thickness in a range from 1 to 5 mm.

20. The tape-laying device according to claim 1, further comprising an ultrasonic device configured to subject the cutter to ultrasound.
